(19) United States
(12) Patent Application Publication
(10) Pub. No.: US 2022/0258705 A1
(43) Pub. Date: Aug. 18, 2022

(54) MITIGATING BRAKING VIBRATION DUE TO ROTOR THICKNESS VARIATIONS

(71) Applicant: GM GLOBAL TECHNOLOGY OPERATIONS LLC, Detroit, MI (US)

(72) Inventors: Hossein Sadjadi, Markham (CA); Milad Jalaliyazdi, Richmond Hill (CA)

(73) Assignee: GM GLOBAL TECHNOLOGY OPERATIONS LLC, Detroit, MI (US)

(21) Appl. No.: 17/174,742

(22) Filed: Feb. 12, 2021

(51) Int. Cl. B60T 8/172; B60T 8/171

(52) U.S. Cl. CPC B60T 8/172; B60T 8/171

(57) ABSTRACT

A braking system includes brake rotors, wheel speed sensors, and an electronic control unit. The brake rotors are couplable to wheels. The brake rotors have rotor thickness variations that cause a vibration while braking. The wheel speed sensors are couplable to the wheels and configured to generate rotation signals for the wheels. The electronic control unit coupled to the wheel speed sensors and configured to generate an absolute phase offset signal that conveys an absolute phase offset angle between the rotor thickness variations in response to the rotation signals, generate a brake torque adjustment signal in response to the absolute phase offset signal and the rotation signals, and adjust a first braking control signal for a first brake rotor relative to a second braking control signal for a second brake rotor based on the brake torque adjustment signal to minimize an amplitude of the vibration during a braking event.

### INTRODUCTION

The present disclosure relates to a system and a method for mitigating braking vibration due to rotor thickness variations.

Rotor thickness variations generally develop on brake rotors over a course of a life of a vehicle. The rotor thickness variations are caused by several factors, such as intense braking, worn brake pads, and wheel misalignments. The thickness variations are typically observed as unwanted vibrations while the brake pads engage the brake rotors during braking operations. The rotor thickness variations generally worsen until excessive vibrations develop and the brake rotors and the brake pads are replaced.

What is desired is a technique for mitigating braking vibration due to rotor thickness variations.

### SUMMARY

A braking system is provided herein. The braking system includes a plurality of brake rotors, a plurality of wheel speed sensors, and an electronic control unit. The plurality of brake rotors are couplable to a plurality of wheels. The plurality of brake rotors has a plurality of rotor thickness variations that cause a vibration while braking. The plurality of wheel speed sensors are couplable to the plurality of wheels and configured to generate a plurality of rotation signals for the plurality of wheels. The electronic control unit is coupled to the plurality of wheel speed sensors and is configured to generate an absolute phase offset signal that conveys an absolute phase offset angle between the plurality of rotor thickness variations in response to the plurality of rotation signals, generate a brake torque adjustment signal in response to the absolute phase offset signal and the plurality of rotation signals, and adjust a first braking control signal for a first brake rotor of the plurality of brake rotors relative to a second braking control signal for a second brake rotor of the plurality of brake rotors based on the brake torque adjustment signal to minimize an amplitude of the vibration during a braking event.

In one or more embodiments of the braking system, the electronic control unit is further configured to convert the plurality of rotation signals into a plurality of wheel speed signals and extract a plurality of high frequency content values from the plurality of wheel speed signals. The plurality of high frequency content values are representative of the plurality of rotor thickness variations.

In one or more embodiments of the braking system, the electronic control unit is further configured to generate an axle correlation value by a correlation analysis of the plurality of high frequency content values to determine a phase gap between the plurality of rotor thickness variations.

In one or more embodiments of the braking system, the electronic control unit is further configured to calculate a relative phase offset value in response to the plurality of rotational signals.

In one or more embodiments of the braking system, the electronic control unit is further configured to estimate an initial phase offset value in response to the relative phase offset value and the axle correlation value over a plurality of braking events.

In one or more embodiments of the braking system, the electronic control unit is further configured to calculate the absolute phase offset angle in response to the relative phase offset value and the initial phase offset value.

In one or more embodiments, the braking system includes a torque vectoring module coupled to a first wheel of the plurality of wheels, coupled to a second wheel of the plurality of wheels, and configured to apply a first torque to the first wheel and a second torque to the second wheel in response to a drive torque adjustment signal. The electronic control unit is further configured to generate the drive torque adjustment signal to establish a phase gap between the plurality of rotor thickness variations that minimizes the amplitude of the vibration during a next braking event.

In one or more embodiments, the braking system includes a plurality of brake actuators disposed adjacent to the plurality of brake rotors and configured to apply a first braking force at the first brake rotor in response to the first braking control signal, and apply a second braking force at the second brake rotor in response to the second braking control signal.

In one or more embodiments of the braking system, the first brake rotor and the second brake rotor are on a common axle.

A method for braking control is provided herein. The method includes generating a plurality of rotation signals with a plurality of wheel speed sensors couplable to a plurality of wheels. The plurality of wheels are couplable to a plurality of brake rotors, and the plurality of brake rotors has a plurality of rotor thickness variations that cause a vibration while braking. The method includes generating an absolute phase offset signal that conveys an absolute phase offset angle between the plurality of rotor thickness variations in response to the plurality of rotation signals.

In one or more embodiments, the method includes generating a brake torque adjustment signal in response to the absolute phase offset signal and the plurality of rotation signals, and adjusting a first braking control signal for a first brake rotor of the plurality of brake rotors relative to a second braking control signal for a second brake rotor of the plurality of brake rotors based on the brake torque adjustment signal to minimize an amplitude of the vibration during a braking event.

In one or more embodiments, the method includes converting the plurality of rotation signals into a plurality of wheel speed signals, and extracting a plurality of high frequency content values from the plurality of wheel speed signals. The plurality of high frequency content values are representative of the plurality of rotor thickness variations.

In one or more embodiments, the method includes generating an axle correlation value by a correlation analysis of the plurality of high frequency content values to determine a phase gap between the plurality of rotor thickness variations.

In one or more embodiments, the method includes calculating a relative phase offset value in response to the plurality of rotational signals.

In one or more embodiments, the method includes estimating an initial phase offset value in response to the relative phase offset value and the axle correlation value over a plurality of braking events.

In one or more embodiments, the method includes calculating the absolute phase offset angle in response to the relative phase offset value and the initial phase offset value.

In one or more embodiments, the method includes generating a drive torque adjustment signal to establish a phase gap between the plurality of rotor thickness variations that minimizes the amplitude of the vibration during a next braking event, and applying a first torque to a first wheel of the plurality of wheels and a second torque to a second wheel of the plurality of wheels in response to the drive torque adjustment signal.

A method for braking control is provided herein. The method includes generating a brake torque adjustment signal in response to an absolute phase offset signal and a plurality of rotation signals for a plurality of wheels, and adjusting a first braking control signal for a first brake rotor of a plurality of brake rotors relative to a second braking control signal for a second brake rotor of the plurality of brake rotors based on the brake torque adjustment signal to minimize an amplitude of a vibration during a braking event.

In one or more embodiments, the method includes generating a drive torque adjustment signal to establish a phase gap between a plurality of rotor thickness variations of the plurality of rotors that minimizes the amplitude of the vibration during a next braking event, and applying a first torque to a first wheel of the plurality of wheels and a second torque to a second wheel of the plurality of wheels in response to the drive torque adjustment signal.

In one or more embodiments, the method includes applying a first braking force at a first brake rotor in response to the first braking control signal, and applying a second braking force at a second brake rotor in response to the second braking control signal. The first brake rotor and the second brake rotor are on a common axle.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram illustrating a context of a vehicle in accordance with one or more exemplary embodiments.

FIG. 2 is a schematic cross-sectional diagram of a brake unit in accordance with one or more exemplary embodiments.

FIG. 3 is a schematic diagram of rotor thickness variations in accordance with one or more exemplary embodiments.

FIG. 4 is a schematic diagram of a phase shift of the rotor thickness variations in accordance with one or more exemplary embodiments.

FIG. 5 is a schematic functional flow diagram of the braking system in accordance with one or more exemplary embodiments.

FIG. 6 is a schematic diagram of an identify absolute phase difference module in accordance with one or more exemplary embodiments.

FIG. 7 is a graph of wheel speeds sampled over multiple braking events in accordance with one or more exemplary embodiments.

FIG. 8 is a graph illustrating wheel speed content values in accordance with one or more exemplary embodiments.

FIG. 9 is a graph of a correlation between high-frequency content values in accordance with one or more exemplary embodiments

FIG. 10 is a graph of a phase gap between brake rotors in accordance with one or more exemplary embodiments.

FIG. 11 is a graph of a relationship between the high-frequency correlation and an absolute phase offset in accordance with one or more exemplary embodiments.

FIG. 12 is a graph of vibrations in a vehicle or in the braking system in accordance with one or more exemplary embodiments.

### DETAILED DESCRIPTION

Embodiments of the disclosure provide a technique to quantify an effect of a phase gap between a pair of wheels (e.g., a left wheel and a right wheel) of a vehicle on vibrations caused by rotor thickness variations. With the phase gap quantified, the technique mitigates the vibration experienced by the vehicle by controlling braking forces or traction forces applied to brake rotors or the wheels based on the observed phase gap. The rotor thickness variations are caused by several factors (e.g., intense braking, worn brake pads, wheel misalignments, etc.) and generally develop on both sides of common axles. The resulting vibrations cause inconveniences for the drivers, but may be mitigated (e.g., by up to 80%) by controlling the phase gap between the left wheel and the right wheel. Various embodiments of the disclosure describe a system and a method to find an optimum phase gap and subsequently controlling the phase gap (thus the resulting vibrations) by adjusting corner brake pressure and/or drive torque to close or reduce the phase gap.

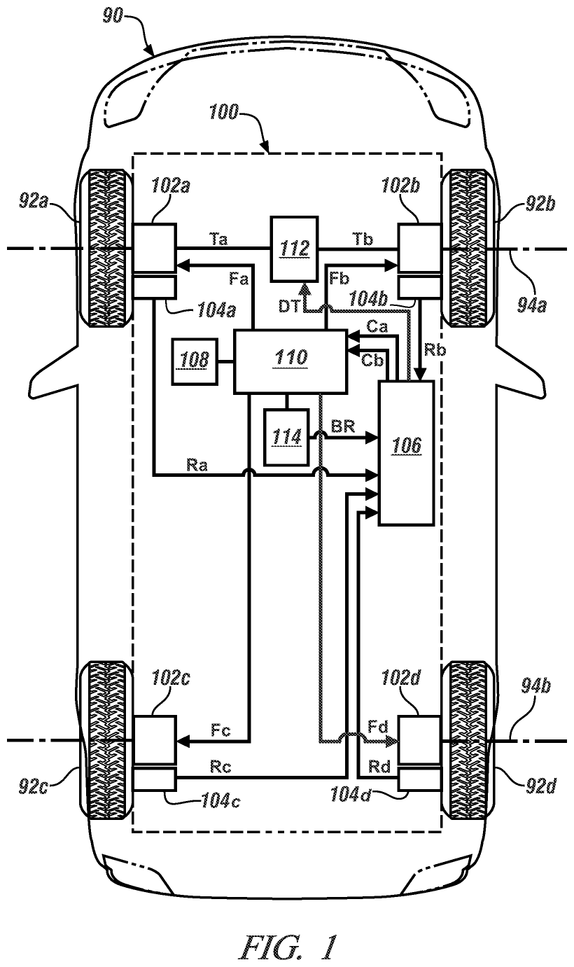

Referring to FIG. 1, a schematic diagram illustrating a context of a vehicle 90 is shown in accordance with one or more exemplary embodiments. The vehicle 90 generally comprises multiple wheels 92a-92d oriented on multiple axles 94a-94b, a braking system 100, and a torque vectoring module 112. The braking system 100 generally comprises multiple brake units 102a-102d, multiple wheel speed sensors 104a-104d, an electronic control unit 106, a master cylinder 108, a hydraulic modulator 110, and a brake pedal 114.

The torque vectoring module 112 generates torque (e.g., Ta and Tb) distributed to the wheels 92a-92d or a subset of the wheels 92a-92d. For example, in a front-wheel drive configuration, the torque vectoring module 112 conveys a first torque Ta to a first wheel 92a and a second torque Tb to a second wheel 92b. In a rear-wheel drive configuration, the torques would be conveyed to the third wheel 92c and the fourth wheel 92d. In an all-wheel drive configuration, the torques would be conveyed to the wheels 92a-92d. FIG. 1 generally illustrates the front-wheel drive configuration.

Multiple rotation signals (e.g., Ra-Rd) are generated by the wheel speed sensors 104a-104d and presented to the electronic control unit 106. The rotation signals Ra-Rd provide timing information and reference information that enables the electronic control unit 106 to determine how fast the wheels 92a-92d are rotating (e.g., an angular velocity) relative to a frame of the vehicle 90. A braking request signal (e.g., BR) is generated by the brake pedal 114 and transferred to the electronic control unit 106. The braking request signal BR generally carries data indicative of how hard a driver is pressing on the brake pedal 114. The electronic control unit 106 generates multiple braking control signals (e.g., Ca-Cb) that are received by the hydraulic modulator 110. The first braking control signal Ca may carry information that controls how hard the hydraulic modulator 110 applies a braking force on the first wheel 92a. The second braking control signal Cb may carry information that controls how hard the hydraulic modulator 110 applies a braking force on the second wheel 92b. Similar braking control signals may be generated for the third wheel 92c and the fourth wheel 92d.

Multiple braking signals (e.g., Fa-Fd) are generated by the hydraulic modulator 110 and presented to the brake units 102a-102d. In various embodiments, the braking signals Fa-Fd are implemented as hydraulic signals that control the brake units 102a-102d. A drive torque adjustment signal (e.g., DT) is generated by the electronic control unit 106 and transferred to the torque vectoring module 112. In various embodiments, the drive torque adjustment signal DT carries data that commands the torque vectoring module 112 to adjust the relative amplitudes of the first torque Ta and the second torque Tb.

The vehicle 90 implements an automobile (or car). In various embodiments, the vehicle 90 may include, but is not limited to, a passenger vehicle, a truck, an autonomous vehicle, a gas-powered vehicle, an electric-powered vehicle, a hybrid vehicle, a motorcycle, a single axle trailer and/or a multiple axle trailer. In other embodiments, the vehicle 90 be a device with multiple rotating wheels that travel together on multiple axles, where an on-board detection of rotor thickness variations would be useful to minimize the resulting vibrations experienced during braking events. Other types of vehicles 90 may be implemented to meet the design criteria of a particular application.

The wheels 92a-92d implement road wheels. The wheels 92a-92d are generally operational to provide for support and movement of the vehicle 90 across the ground. In various embodiments, each wheel 92a-92d may include a tire mounted on a rim. The wheels 92a-92d may be used to provide traction between the vehicle 90 and the ground upon which the vehicle 90 is sitting. The first wheel 92a and the second wheel 92b may be aligned along the first (e.g., front) axle 94a. The third wheel 92c and the fourth wheel 92d may be aligned along the second (e.g., rear) axle 94b.

The braking system 100 is generally operational to minimize a vibration caused by rotor thickness variations while the vehicle 90 is braking. The braking system 100 generates rotation information based on the rotations of the wheels 92a-92d. An absolute phase offset angle between rotor thickness variations for a pair of the wheels (e.g., 92a-92b) on a common axle (e.g., the first axle 94a) is calculated in response to the rotation information. Brake torque adjustment data is calculated in response to the absolute phase offset angle and the rotation information. First braking control information for a first brake rotor and second braking control information for a second brake rotor is generated based on the brake torque adjustment signal to minimize an amplitude of the vibration during braking events.

The brake units 102a-102d implement friction brakes. While the brake pedal 114 is activated (e.g., pressed), the brake units 102a-102d are operational to apply braking forces to the wheels 92a-92d in response to the braking signals Fa-Fd generated by the hydraulic modulator 110. While the brake pedal 114 deactivated (e.g., not pressed), the brake units 102a-102d allow the wheels 92a-92d to spin without interruption.

The wheel speed sensors 104a-104d implement on-board corner wheel speed encoders. The wheel speed sensors 104a-104d generate the rotation information in the rotation signal Ra-Rd. In various embodiments, the rotation information may include, but is not limited to, timestamp information, roll-over counter information, and pulse counter information. The rotation information allows the electronic control unit 106 to determine the angular velocity of the wheels 92a-92d as a function of time.

The electronic control unit 106 implements one or more processors. The electronic control unit 106 is operational to generate an absolute phase offset signal that conveys an absolute phase offset angle between the rotor thickness variations in the brake units 102a-102d in response to the rotation signals. For pairs of the wheels (e.g., 92a-92b), the electronic control unit 106 also generates a brake torque adjustment signal in response to the absolute phase offset signal and the rotation signals, and adjusts the first braking control signal Ca for a first brake rotor relative to the second braking control signal Cb for a second brake rotor based on the brake torque adjustment signal to minimize an amplitude of the vibration caused by the rotor thickness variations during braking events. The braking control signals Ca-Cb are presented to the hydraulic modulator 110 to implement braking differences in the corresponding braking signals Fa-Fb. The braking differences are controlled by the electronic control unit 106 to minimize the vibration caused by the rotor thickness variations between the first brake unit 102a and the second brake unit 102b. The electronic control unit 106 may make similar adjustments to minimize the vibration caused by the rotor thickness variations between the third brake unit 102c and the fourth brake unit 102d.

The electronic control unit is also operational to generate the drive torque adjustment signal DT to establish a phase gap between the rotor thickness variations that minimizes the amplitude of the vibration during a next braking event. Data in the drive torque adjustment signal DT commands the torque vectoring module 112 to adjust the first torque Ta and the second torque Tb to establish an optimal phase gap between the first brake unit 102a and the second brake unit 102b such that during a next braking event, the two rotor thickness variations are aligned to minimize the vibrations. Similar adjustments may be made on the second axle 94b to establish an optimal phase gap between the third brake unit 102c and the fourth brake unit 102d.

The master cylinder 108 implements a hydraulic pressure control device. The master cylinder 108 is operational to convert a mechanical force received from the brake pedal 114 into a hydraulic pressure. The hydraulic pressure is presented to the hydraulic modulator 110.

The hydraulic modulator 110 implements a hydraulic distribution and control device. The hydraulic modulator 110 is operational to distribute the hydraulic pressure received from the master cylinder 108 to the brake units 102a-102d in the brake signals Fa-Fd. The hydraulic modulator 110 generally assures that each wheel 92a-92d receives a correct brake force to minimize the rotor thickness variation induced vibrations.

The torque vectoring module 112 is operational to vary the torques applied to the wheels 92a-92d. In the example front-wheel drive configuration, the torque vectoring module 112 varies the first torque Ta applied to the first wheel 92a relative to the second torque Tb applied to the second wheel 92b based on the drive torque adjustment signal DT.

The brake pedal 114 implements an electro/mechanical sensor. The brake pedal 114 is operational to provide the mechanical force to the master cylinder 108 to cause braking. The brake pedal 114 is also operational to provide the braking request signal BR in the form of an electrical signal to the electronic control unit 106.

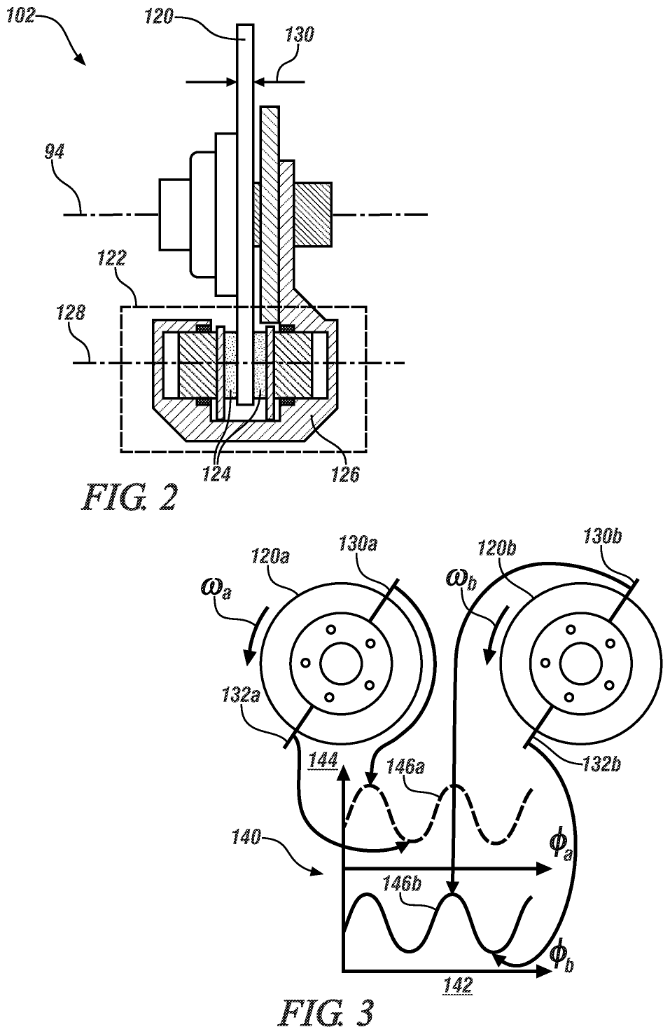

Referring to FIG. 2, a schematic cross-sectional diagram of an example implementation of a brake unit 102 is shown in accordance with one or more exemplary embodiments. The brake unit 102 includes a brake rotor 120 and a brake actuator 122. The brake actuator 122 includes multiple (e.g., two) brake pads 124 and calipers 126. The brake unit 102 is representative of each brake unit 102a-102d. The brake rotor 120 is representative of a first brake rotor 120a, a second brake rotor 120b, a third brake rotor 120c, and a fourth brake rotor 120d.

The brake rotor 120 is aligned to rotate around the common axle 94. The brake pads 124 are disposed in the calipers 126 adjoining the brake rotor 120. The brake pads 124 are configured to apply a braking force 128 to the brake rotor 120 while the corresponding braking signal Fa-Fd (FIG. 1) is active. A rotor thickness variation 130 is worn into the brake rotor 120 over time. The rotor thickness variation 130 causes a vibration in the brake unit 102 during braking events.

Referring to FIG. 3, a schematic diagram of example rotor thickness variations is shown in accordance with one or more exemplary embodiments. The example illustrates two brake rotors 120a-120b rotating at rates ωa and ωb, respectively. The brake rotors 120a-120b have variable thicknesses with high points 130a-130b and low points 132a-132b. A graph 140 illustrates the rotor thickness variations of the first brake rotor 120a and the second brake rotor 120b as a function of time. An axis 142 of the graph 140 illustrates time. An axis 144 of the graph 140 illustrate the rotor thickness. A curve 146a illustrates the rotor thickness of the first brake rotor 120a. A curve 146b illustrates the rotor thickness of the second brake rotor 120b. For purposes of explanation, the curves 146a and 146b illustrate a first order sine wave cycle over the 360 degrees of the brake rotors 120a and 120b. In various situations, higher order thickness variations may exist. For example, two sine wave cycles may exist over the 360 degrees. As the brake rotors 120a-120b spin, the rotor thicknesses passing a reference point in space may vary (oscillate) as the phase angles φa-φb of the brake rotors 120a-120b change. In the example, the high points 130a-130b and the low points 132a-132b are aligned (e.g., a zero phase gap is illustrated).

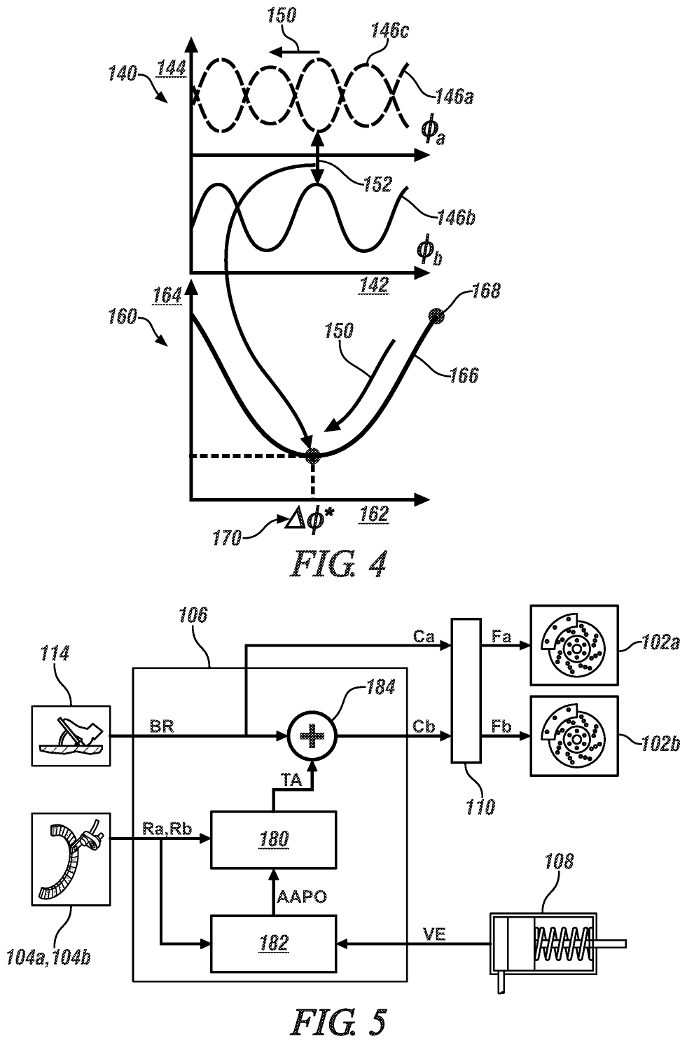

Referring to FIG. 4, a schematic diagram of an example phase shift of the rotor thickness variations is shown in accordance with one or more exemplary embodiments. A graph 160 illustrates a vibration amplitude as a function of a phase gap. An axis 162 of the graph 160 illustrates the absolute phase gap (e.g., φa-φb). An axis 164 of the graph 160 illustrates the vibration amplitude. A curve 166 illustrates amplitude of the vibration during braking events.

A starting point 168 of the curve 166 illustrates an example vibration amplitude while the brake rotors 120a-120b aligned. The braking system 100 may adjust the phase gap by causing a phase shift 150 in one of the brake rotors (e.g., the first brake rotor 120a). The phase shift 150 changes an angular displacement of the first high/low points 130a/132a of the first brake rotor 120a relative to the second high/low points 130b/132b of the second brake rotor 120b to an optimal phase alignment 152 condition. From the graph 140 point of view, the phase shift 150 moves the first rotor thickness curve 146a to a shifted first rotor thickness curve 146c. In the example, the first low point 132a of the first brake rotor 120a is aligned with the second high point 130b of the second brake rotor 120b at the optimal phase alignment 152. From the graph 160 point of view, the phase shift 150 moves the starting point 168 to an optimal phase differential point 170 (e.g., Δφ*). At the optimal phase differential point Δφ*, the amplitude of the vibration caused by the rotor thickness variations is at a lowest value along the curve 166. The optimal phase differential point Δφ*may vary over time and may be something other than the 180 degree phase gap as illustrated. The lowest amplitude vibration results in improved life of the brake rotors 120a-120b and provides a smoother braking experience for the vehicle 90.

Referring to FIG. 5, a schematic functional flow diagram of an example operation of the braking system 100 is shown in accordance with one or more exemplary embodiments. The example illustrates an application of the technique to the brake units 102a-102b of the front wheels 92a-92b. The same technique may be applied to the brake units 102c-102d of the rear wheels 92c-92d.

The electronic control unit 106 includes a phase adjustment controller 180, an identify absolute phase difference module 182, and a summation module 184. The braking request signal BR is received by the summation module 184. The first braking control signal Ca is presented by the electronic control unit 106 as a copy of the braking request signal BR. The second braking control signal Cb is generated by the summation module 184. The rotation signals Ra-Rb are received from the wheel sensors 104a-104b by the phase adjustment controller 180 and the identify absolute phase difference module 182. A vibration envelope signal (e.g., VE) is generated by the master cylinder 108 and presented to the identify absolute phase difference module 182. The vibration envelope signal VE generally conveys date for vibrations in the master cylinder pressure. The identify absolute phase difference module 182 may generate an axle absolute phase offset signal (e.g., AAPO). The axle absolute phase offset signal AAPO may carry data that identifies the optimal phase difference point Δφ*. A brake torque adjustment signal (e.g., TA) may be generated by the phase adjustment controller 180 and received by the summation module 184. The brake torque adjustment signal TA may transfer a torque adjustment value δT.

The phase adjustment controller 180 is operational to calculate the torque adjustment value δT based on the rotation information in the rotation signal Ra-Rb and the optimal phase difference point Δφ*in the axle absolute phase offset signal AAPO.

The identify absolute phase difference module 182 is operational to determine the optimal phase difference point Δφ*based on the rotation information in the rotational signals Ra-Rb and the master cylinder pressure data in the vibration envelope signal VE.

The summation module 184 is operational to add the amplitude in the braking request signal BR with the torque adjustment value δT to generate the second braking control signal Cb. The torque adjustment value δT applied to the braking request amplitude causes a difference in the braking forces 128 (FIG. 2) applied to the brake rotors 120a-120b and thus creates the phase shift 150 (FIG. 4).

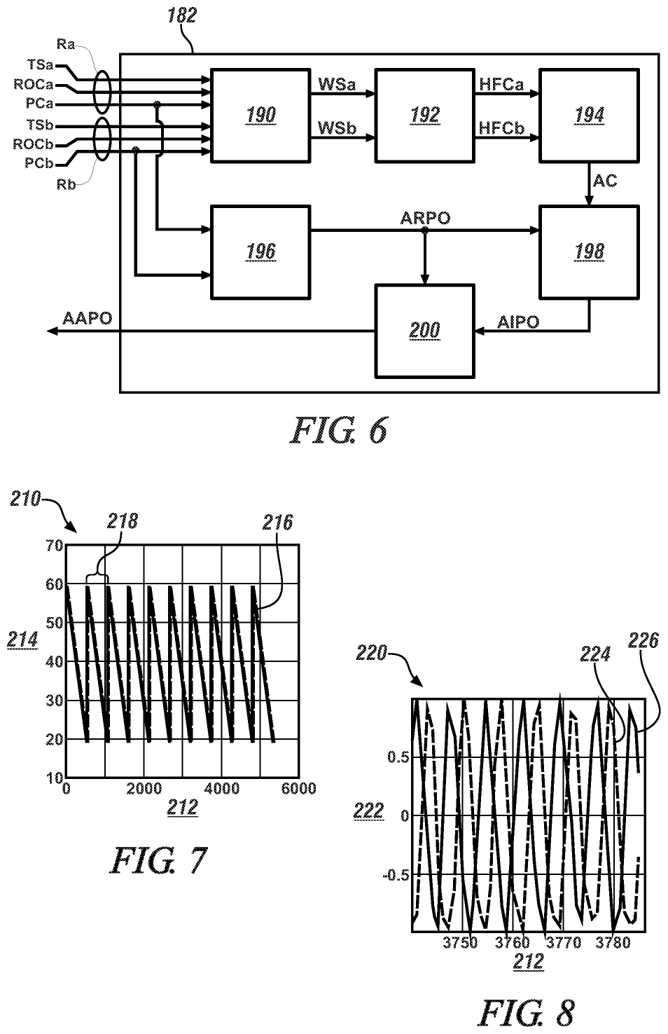

Referring to FIG. 6, a schematic diagram of an example implementation of the identify absolute phase difference module 182 is shown in accordance with one or more exemplary embodiments. The identify absolute phase difference module 182 includes a wheel speed conversion module 190, a high frequency content extraction module 192, a correlation analysis module 194, a relative phase calculation module 196, an initial phase estimation module 198, and an absolute phase calculation module 200.

The rotation signals Ra-Rb are received by the wheel speed conversion module 190 and the relative phase calculation module 196. The axle absolute phase offset signal AAPO is generated and presented by the absolute phase calculation module 200. The rotation signals Ra-Rb each include a timestamp value TSa-TSb, a roll-over counter value ROCa-ROCb, and a pulse counter value PCa-PCb. The wheel speed conversion module 190 generates wheel speed values in wheel speed signals (e.g., WSa-WSb) that are received by the high frequency content extraction module 192. The high frequency content extraction module 192 generates high-frequency content values in high-frequency content signals (e.g., HFCa-HFCb) presented to the correlation analysis module 194. An axle correlation value in an axle correlation signal (e.g., AC) is generated by the correlation analysis module 194 and received by the initial phase estimation module 198.

The relative phase calculation module 196 generates and presents an axle relative phase offset value in an axle relative phase offset signal (e.g., ARPO) to the initial phase estimation module 198 and the absolute phase calculation module 200. The initial phase estimation module 198 generates an axle initial phase offset value in an axle initial phase offset signal (e.g., AIPO) conveyed to the absolute phase calculation module 200.

The wheel speed conversion module 190 is operational to generate the wheel speed signals WSa-WSb in response to the timestamp values TSa-TSb, the roll-over counter values ROCa-ROCb, and the pulse counter values PCa-PCb. The wheel speed signals WSa-WSb are generated based on a specification of the wheel speed sensors 104a-104d (e.g., number of pulses per revolution, memory buffer sizes, signal resolutions, etc.).

The high frequency content extraction module 192 is operational to extract high-frequency information from the wheel speed signals WSa-WSb. Once the wheel speed signals WSa-WSb are available, the high-frequency information is generated by high pass filtering the wheel speed signals WSa-WSb. The extracted high-frequency information is presented to the correlation analysis module 194 in the high-frequency content signals HFCa-HFCb.

The correlation analysis module 194 is operational to generate the axle correlation signal AC by analyzing the high-frequency content signals HFCa-HFCb. The analysis may be a normal correlation calculation of the two high frequency content signals HFCa and HFCb. The axle correlation signal AC may be presented to the initial phase estimation module 198.

The relative phase calculation module 196 is operational to generate the axle relative phase offset signal ARPO by calculating a relative phase of the first pulse counter value PCa relative to the second pulse counter value PCb. The relative phase calculation module 196 subtracts the pulse counter values PCa and PCb of the two wheels and with some conversions, keeps track of the difference in the angular orientation of the two wheels.

The initial phase estimation module 198 is operational to create the axle initial phase offset signal AIPO based on the axle correlation signal AC and the axle relative phase offset signal ARPO. The axle initial phase offset value is generally calculated over multiple braking events for an accurate estimation. Given data from the various braking events, the initial phase estimation module 198 fits a model to “AC vs ARPO” and reports a value in the axle initial phase offset signal AIPO that maximizes the axle correlation signal AC as the value in the axle relative phase offset signal ARPO.

The absolute phase calculation module 200 is operational to generate a value in the axle absolute phase offset signal AAPO based on the axle initial phase offset value AIPO and the axle relative phase offset value ARPO. The value in the axle absolute phase offset signal AAPO may be a sum of the initial phase value to the relative phase value.

Referring to FIG. 7, a graph 210 of example wheel speeds sampled over multiple braking events is shown in accordance with one or more exemplary embodiments. An axis 212 of the graph 210 illustrates wheel speed samples measured over time on a test vehicle. An axis 214 of the graph 210 illustrates the wheel speed of the test vehicle in units of kilometers per hour (km/h). The curve 216 shows the wheel speed during multiple braking events. A single braking event is identified by the bracket 218 and generally slows the wheel speed slowing from a first speed (e.g., approximately 60 km/h) to a slower second speed (e.g., approximately 20 km/h).

In the vehicle 90, the braking events 218 are buffered in a memory within the electronic control unit 106. The braking events 218 are subsequently used to obtain the absolute phase difference between the first wheel 92a and the second wheel 92b. The curve 216 may be representative of the wheel speed values WSa-WSb generated by the wheel speed conversion module 190.

Referring to FIG. 8, a graph 220 of example wheel speed content values is shown in accordance with one or more exemplary embodiments. The axis 212 of the graph 220 illustrates the wheel speed samples measured on the test vehicle. An axis 222 of the graph 220 illustrates the content values normalized to a range of −0.5 to +0.5. A curve 224 represents a first content value. A curve 226 represent a second content value.

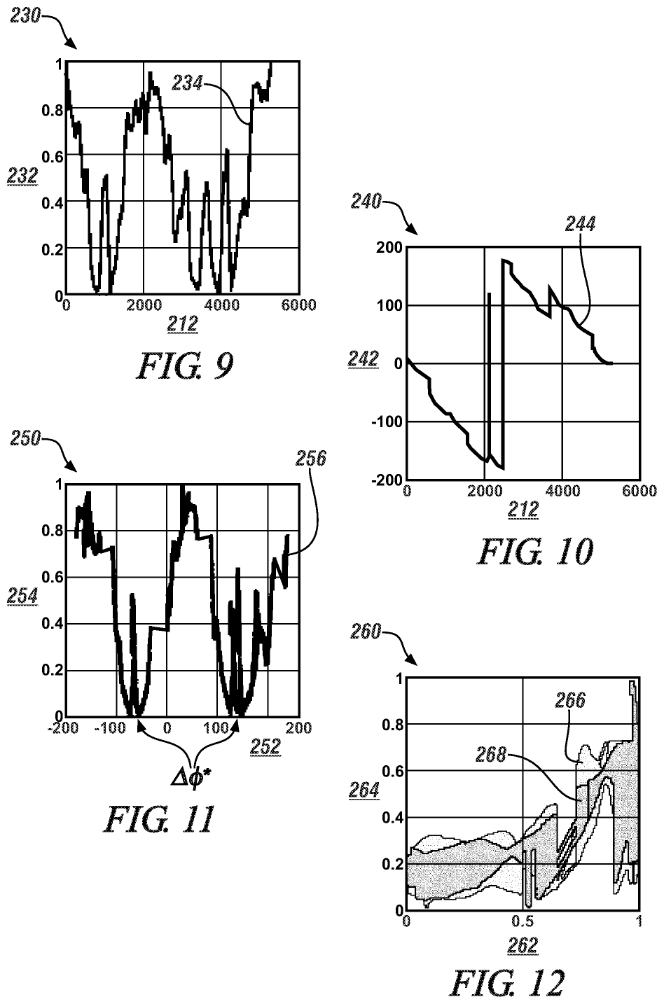

Referring to FIG. 9, a graph 230 of an example correlation between the high-frequency content values is shown in accordance with one or more exemplary embodiments. The axis 212 of the graph 230 illustrates the wheel speed samples measured on the test vehicle. An axis 232 of the graph 230 illustrates range axle correlation values. A curve 234 shows the axle correlation value AC during the multiple braking events. The correlation may be implemented by the correlation analysis module 194.

Referring to FIG. 10, a graph 240 of an example resulting phase gap between the brake rotors is shown in accordance with one or more exemplary embodiments. The axis 212 of the graph 240 illustrates the wheel speed samples measured on the test vehicle. An axis 242 of the graph 240 illustrates a phase offset in units of degrees. A curve 244 shows the estimated value in the absolute axle phase offset signal AAPO. The phase gap is generally calculated by the absolute phase calculation module 200.

Referring to FIG. 11, a graph 250 of an example relationship between the high-frequency correlation and the absolute phase offset is shown in accordance with one or more exemplary embodiments. An axis 252 of the graph 250 illustrates the absolute phase offset in units of degrees. An axis 254 of the graph 250 illustrated the high-frequency correlation. A curve 256 shows the correlation of the high frequency content of the wheel speeds between two wheels versus the absolute phase offset. The graph 250 generally shows how the initial phase estimation module 198 provides an estimate of the initial phase offset such that a maximum high-frequency correlation occurs at approximately 0 degrees absolute phase offset. Minimum high-frequency correlations (e.g., at the optimal phase differential points Δφ*) are shown at approximately +90 degrees and −90 degrees in the example.

Referring to FIG. 12, a graph 260 of an example vibrations in a vehicle or in the braking system is shown in accordance with one or more exemplary embodiments. An axis 262 of the graph 260 illustrates an absolute value of a cosine of absolute phase offsets. An axis 264 of the graph 260 illustrates amplitudes of the vibrations normalized to a range of 0 to 1. A curve 266 shows the brake vibration of the master cylinder pressure. A curve 268 shows the vehicle vibration (generally experienced by the driver as a brake judder). The graph 260 shows that when the phase gap is controlled to an optimal value (e.g., a leftmost point in the graph 260), the vibration is reduced to a lowest value.

The disclosure describes a technique to calculate an optimum phase gap that minimizes vehicle vibration due to rotor thickness variations. The technique further leverages the effect of the phase gap between the left wheel and the right wheel on the induced vibration to achieve/maintain the optimal phase gap that results in minimal vibration of the vehicle. The vibration is mitigated through controlling the brake pressure and/or acceleration torque where the powertrain permits. The technique may actively reduce the brake judder by controlling the phase gap. The technique also improves ride quality and allows for brake rotors to be in service longer before being replaced.

While the best modes for carrying out the disclosure have been described in detail, those familiar with the art to which this disclosure relates will recognize various alternative designs and embodiments for practicing the disclosure within the scope of the appended claims.

What is claimed is:

1. A braking system comprising:
a plurality of brake rotors couplable to a plurality of wheels, wherein the plurality of brake rotors has a plurality of rotor thickness variations that cause a vibration while braking;
a plurality of wheel speed sensors couplable to the plurality of wheels and configured to generate a plurality of rotation signals for the plurality of wheels; and
an electronic control unit coupled to the plurality of wheel speed sensors and configured to generate an absolute phase offset signal that conveys an absolute phase offset angle between the plurality of rotor thickness variations in response to the plurality of rotation signals, generate a brake torque adjustment signal in response to the absolute phase offset signal and the plurality of rotation signals, and adjust a first braking control signal for a first brake rotor of the plurality of brake rotors relative to a second braking control signal for a second brake rotor of the plurality of brake rotors based on the brake torque adjustment signal to minimize an amplitude of the vibration during a braking event.

2. The braking system according to claim 1, wherein the electronic control unit is further configured to convert the plurality of rotation signals into a plurality of wheel speed signals and extract a plurality of high frequency content values from the plurality of wheel speed signals, wherein the plurality of high frequency content values are representative of the plurality of rotor thickness variations.

3. The braking system according to claim 2, wherein the electronic control unit is further configured to generate an axle correlation value by a correlation analysis of the plurality of high frequency content values to determine a phase gap between the plurality of rotor thickness variations.

4. The braking system according to claim 3, wherein the electronic control unit is further configured to calculate a relative phase offset value in response to the plurality of rotational signals.

5. The braking system according to claim 4, where the electronic control unit is further configured to estimate an initial phase offset value in response to the relative phase offset value and the axle correlation value over a plurality of braking events.

6. The braking system according to claim 5, wherein the electronic control unit is further configured to calculate the absolute phase offset angle in response to the relative phase offset value and the initial phase offset value.

7. The braking system according to claim 1, further comprising a torque vectoring module coupled to a first wheel of the plurality of wheels, coupled to a second wheel of the plurality of wheels, and configured to apply a first torque to the first wheel and a second torque to the second wheel in response to a drive torque adjustment signal, wherein the electronic control unit is further configured to generate the drive torque adjustment signal to establish a phase gap between the plurality of rotor thickness variations that minimizes the amplitude of the vibration during a next braking event.

8. The braking system according to claim 1, further comprising a plurality of brake actuators disposed adjacent to the plurality of brake rotors and configured to apply a first braking force at the first brake rotor in response to the first braking control signal, and apply a second braking force at the second brake rotor in response to the second braking control signal.

9. The braking system according to claim 1, wherein the first brake rotor and the second brake rotor are on a common axle.

10. A method for braking control comprising:
generating a plurality of rotation signals with a plurality of wheel speed sensors couplable to a plurality of wheels, wherein the plurality of wheels are couplable to a plurality of brake rotors, and the plurality of brake rotors has a plurality of rotor thickness variations that cause a vibration while braking; and
generating an absolute phase offset signal that conveys an absolute phase offset angle between the plurality of rotor thickness variations in response to the plurality of rotation signals.

11. The method according to claim 10, further comprising:
generating a brake torque adjustment signal in response to the absolute phase offset signal and the plurality of rotation signals; and
adjusting a first braking control signal for a first brake rotor of the plurality of brake rotors relative to a second braking control signal for a second brake rotor of the plurality of brake rotors based on the brake torque adjustment signal to minimize an amplitude of the vibration during a braking event.

12. The method according to claim 11, further comprising:
converting the plurality of rotation signals into a plurality of wheel speed signals; and
extracting a plurality of high frequency content values from the plurality of wheel speed signals, wherein the plurality of high frequency content values are representative of the plurality of rotor thickness variations.

13. The method according to claim 12, further comprising:
generating an axle correlation value by a correlation analysis of the plurality of high frequency content values to determine a phase gap between the plurality of rotor thickness variations.

14. The method according to claim 13, further comprising:
calculating a relative phase offset value in response to the plurality of rotational signals.

15. The method according to claim 14, further comprising:
estimating an initial phase offset value in response to the relative phase offset value and the axle correlation value over a plurality of braking events.

16. The method according to claim 15, further comprising:
calculating the absolute phase offset angle in response to the relative phase offset value and the initial phase offset value.

17. The method according to claim 11, further comprising:
generating a drive torque adjustment signal to establish a phase gap between the plurality of rotor thickness variations that minimizes the amplitude of the vibration during a next braking event; and
applying a first torque to a first wheel of the plurality of wheels and a second torque to a second wheel of the plurality of wheels in response to the drive torque adjustment signal.

18. A method for braking control comprising:
generating a brake torque adjustment signal in response to an absolute phase offset signal and a plurality of rotation signals for a plurality of wheels; and
adjusting a first braking control signal for a first brake rotor of a plurality of brake rotors relative to a second braking control signal for a second brake rotor of the plurality of brake rotors based on the brake torque adjustment signal to minimize an amplitude of a vibration during a braking event.

19. The method according to claim 18, further comprising:
generating a drive torque adjustment signal to establish a phase gap between a plurality of rotor thickness variations of the plurality of brake rotors that minimizes the amplitude of the vibration during a next braking event; and
applying a first torque to a first wheel of the plurality of wheels and a second torque to a second wheel of the plurality of wheels in response to the drive torque adjustment signal.

20. The method according to claim 19, further comprising:
applying a first braking force at a first brake rotor in response to the first braking control signal; and
applying a second braking force at a second brake rotor in response to the second braking control signal, wherein the first brake rotor and the second brake rotor are on a common axle.
